(19) United States
(12) Patent Application Publication
(10) Pub. No.: US 2026/0096600 A1
(43) Pub. Date: Apr. 9, 2026

(54) ATOMIZER, ELECTRONIC ATOMIZATION DEVICE, POROUS BODY, AND PREPARATION METHOD

(71) Applicant: SHENZHEN FIRST UNION TECHNOLOGY CO., LTD., Shenzhen, Guangdong (CN)

(72) Inventors: Xuanming LU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/114,285

(22) PCT Filed: Sep. 11, 2023
(86) PCT No.: PCT/CN2023/117980

§ 371 Date: Mar. 21, 2025

(30) Foreign Application Priority Data
Sep. 23, 2022 (CN) 202211165307.8

(51) Int. Cl. A24F 40/44; A24F 40/10; A24F 40/46; A24F 40/70; H05B 3/22

(52) U.S. Cl. CPC A24F 40/44; A24F 40/10; A24F 40/46; A24F 40/70; H05B 3/22

(57) ABSTRACT

An atomizer, an electronic atomization device, a porous body, and a preparation method are provided. The atomizer includes: an e-liquid storage cavity, configured to store an e-liquid matrix; a porous body, communicated to the e-liquid storage cavity to absorb the e-liquid matrix; and a heating element, at least partially bonded with the porous body, to heat at least part of the e-liquid matrix in the porous body to generate an aerosol. The porous body is formed by sintering gel, and the gel is obtained by gelation of sol that contains silicon and/or a metal.

### CROSS-REFERENCE TO RELATED APPLICATIONS

This application claims priority to Chinese Patent Application No. 202211165307.8, filed with the China National Intellectual Property Administration on Sep. 23, 2022 and entitled “ATOMIZER, ELECTRONIC ATOMIZATION DEVICE, POROUS BODY, AND PREPARATION METHOD”, which is incorporated herein by reference in its entirety.

### TECHNICAL FIELD

Embodiments of the present application relate to the technical field of electronic atomization, and in particular, to an atomizer, an electronic atomization device, a porous body, and a preparation method.

### BACKGROUND

Tobacco products (such as cigarettes, cigars, and the like) burn tobacco during use to produce tobacco smoke. Attempts are made to replace these tobacco-burning products by making products that release compounds without burning.

An example of such products is a heating device, which releases compounds by heating rather than burning materials. For example, the material may be tobacco or other non-tobacco products. These non-tobacco products may or may not include nicotine. In another example, aerosol-providing articles are provided, for example, a so-called electronic atomization device. In an existing electronic atomization device, e-liquid is absorbed by using a porous body element having internal micropores, such as a porous ceramic body, and the e-liquid is heated by using a heat element bonded with the porous body element, to generate an aerosol. It is known that the porous body element, such as the porous ceramic body, is prepared by adding a pore-forming material such as graphite powder, carbon powder, wood powder, or a starch, into a ceramic raw material and then sintering the raw material. During the sintering, the pore-forming material is decomposed or volatilized, so that the internal micropores of the porous body element are formed in a space occupied by the pore-forming material.

### SUMMARY

An embodiment of the present application provides an atomizer, including:
an e-liquid storage cavity, configured to store an e-liquid matrix;
a porous body, communicated to the e-liquid storage cavity to absorb the e-liquid matrix; and
a heating element, at least partially bonded with the porous body, to heat at least part of the e-liquid matrix in the porous body to generate an aerosol,
where the porous body is formed by sintering gel, and the gel is obtained by gelation of sol that contains silicon and/or a metal.

In some implementations, the sol that contains the silicon and/or the metal includes a silicon source precursor and/or a metal source precursor, a water-soluble polymer, and a solvent.

In some implementations, the silicon source precursor includes at least one of methyl orthosilicate, ethyl orthosilicate, methyl trimethoxy-silane, methyl trihexaoxy-silane, and a derivative;
and/or, the metal source precursor includes at least one of an organic alkoxide of the metal and an inorganic salt of the metal.

In some implementations, the porous body includes:
a framework network, where a surface of the framework network defines micropores for allowing an e-liquid matrix to flow;
the surface is smooth; and/or the surface is smoother than a surface of a framework of porous ceramic obtained by sintering a pore-forming material.

In some implementations, a void ratio of the porous body is 55% to 80%.

In some implementations, a median pore diameter of each micropore in the porous body is in a range of 0.3 to 50 micrometers.

In some implementations, the porous body includes less than three types of oxides with mass percentage exceeding 5%.

In some implementations, the porous body includes silicon dioxide.

In some implementations, when the void ratio of the porous body is greater than 60%, strength of the porous body is greater than 35 Mpa.

In some implementations, the micropores in the porous body are basically uniformly distributed in the whole porous body.

In some implementations, the micropores in the porous body are basically three-dimensionally connected, to form a network of interconnected holes in the porous body.

In some implementations, a proportion of micropores, having the pore diameters of 15 to 36 micrometers, among all the micropores in the porous body is greater than 80%.

In some implementations, a proportion of micropores, having the pore diameters of 5 to 20 micrometers, among all the micropores in the porous body is greater than 90%.

In some implementations, an absorption rate of the porous body on the e-liquid matrix is greater than 5.0 mg/s;
and/or, an absorption rate of the porous body on the e-liquid matrix is greater than an absorption rate of the porous ceramic obtained by sintering the pore-forming material on the e-liquid matrix.

In some implementations, the porous body includes an atomization surface;
the heating element is formed by combining resistive slurry with the atomization surface and then sintering the resistive slurry;
the heating element is at least partially embedded into the porous body and is partially exposed out of the atomization surface; and an exposed surface of the heating element on the atomization surface is basically flush with the atomization surface.

In some implementations, the porous body includes:
a framework network;
first-level micropores, where boundaries of the first-level micropores are defined by a surface of the framework network, to provide channels for allowing the e-liquid matrix to flow; and
second-level micropores, formed inside a material of the framework network.

In some implementations, the first-level micropores are basically open pores; or, a quantity of the open pores in the first-level micropores is greater than a quantity of closed pores.

In some implementations, the second-level micropores are basically closed pore; or, a quantity of the closed pores in the second-level micropores is greater than a quantity of open pores.

In some implementations, the first-level micropores are at least partially defined by a space occupied by a solvent that loses fluidity in the gel;
and/or, the second-level micropores are at least partially formed by shrinkage, in the sintering process, of the gel material forming the framework network.

In some implementations, a median pore diameter of each first-level micropore is greater than a median pore diameter of each second-level micropore.

In some implementations, the median pore diameter of each second-level micropore is less than 2 μm;
or, the median pore diameter of each second-level micropore is between 0.1 μm and 1 μm.

In some implementations, the first-level micropores are basically connected to each other between the framework networks;
and/or, the second-level micropores are basically separated or discretely arranged inside the material of the framework network.

In some implementations, the second-level micropores are clearly visible on a scanning electron microscope at a magnification of more than 300 times.

In some implementations, the existence of the second-level micropores are detected by using a scanning electron microscope and/or a nitrogen adsorption and desorption test;
and/or, the existence of the second-level micropores is undetected by a mercury intrusion method.

In some implementations, the porous body includes:
at least one surface layer portion; the surface layer portion has a pore diameter and/or a void ratio less than a pore diameter and/or a void ratio of another portion of the porous body.

In some implementations, a thickness of the surface layer portion is 0.1 to 100 micrometers.

In some implementations, the void ratio of the surface layer portion is less than 50%;
and/or, a pore diameter of each micropore in the surface layer portion is 0.5 to 5 μm.

In some implementations, the porous body includes:
a first surface, configured to be in fluid connection to the e-liquid storage cavity to receive the e-liquid matrix from the e-liquid storage cavity; and
the first surface is arranged to avoid the surface layer portion.

In some implementations, the porous body includes:
a second surface; the heating element is at least partially arranged on the second surface; and
the second surface is at least partially formed or defined by the surface layer portion.

In some implementations, the porous body is basically block-shaped or sheetlike or plate-like.

Another implementation of the present application further provides an atomizer, including:
an e-liquid storage cavity, configured to store an e-liquid matrix;
a porous body, communicated to the e-liquid storage cavity to absorb the e-liquid matrix; and
a heating element, at least partially bonded with the porous body, to heat at least part of the e-liquid matrix in the porous body to generate an aerosol,
where the porous body includes:
a framework network, where a surface of the framework network defines micropores for allowing an e-liquid matrix to flow;
the surface is smooth; alternatively, the surface is smoother than a surface of a framework constructed by decomposing or volatilizing porous ceramic in a sintering process.

Another implementation of the present application further provides an atomizer, including:
an e-liquid storage cavity, configured to store an e-liquid matrix;
a porous body, communicated to the e-liquid storage cavity to absorb the e-liquid matrix; and
a heating element, at least partially bonded with the porous body, to heat at least part of the e-liquid matrix in the porous body to generate an aerosol,
an absorption rate of the porous body on the e-liquid matrix is greater than 5.0 mg/s; and/or, an absorption rate of the porous body on the e-liquid matrix is greater than an absorption rate of the porous ceramic obtained by sintering a raw material containing the pore-forming material on the same e-liquid matrix.

Another implementation of the present application further provides an electronic atomization device, including an atomizer configured to atomize an e-liquid matrix to generate an aerosol, and a power supply mechanism for supplying power to the atomizer, where the atomizer includes the atomizer described above.

Still another implementation of the present application further provides a porous body for an electronic atomization device, where the porous body is formed by sintering gel, and the gel is obtained by gelation of sol that contains silicon and/or a metal.

Yet another implementation of the present application further provides a preparation method of a porous body for an electronic atomization device, including: sintering gel obtained by gelation of sol that contains silicon and/or a metal.

In some implementations, the sol that contains the silicon and/or the metal includes a silicon source precursor and/or a metal source precursor, a water-soluble polymer, and a solvent.

In some implementations, the silicon source precursor includes at least one of methyl orthosilicate, ethyl orthosilicate, methyl trimethoxy-silane, methyl trihexaoxy-silane, and a derivative;
and/or, the metal source precursor includes at least one of an organic alkoxide of the metal and an inorganic salt of the metal.

Still yet another embodiment of the present application further provides an atomizer, including:
an e-liquid storage cavity, configured to store an e-liquid matrix;
a porous body, communicated to the e-liquid storage cavity to absorb the e-liquid matrix; and
a heating element, at least partially bonded with the porous body, to heat at least part of the e-liquid matrix in the porous body to generate an aerosol,
where the porous body includes at least one surface layer portion; and the surface layer portion has a void ratio and/or a median pore diameter less than a void ratio and/or the median pore diameter of another portion of the porous body.

Still yet another embodiment of the present application further provides an atomizer, including:
an e-liquid storage cavity, configured to store an e-liquid matrix;
a porous body, communicated to the e-liquid storage cavity to absorb the e-liquid matrix; and
a heating element, at least partially bonded with the porous body, to heat at least part of the e-liquid matrix in the porous body to generate an aerosol,
where the porous body includes:
a framework network;
first-level micropores, where boundaries of the first-level micropores are defined by a surface of the framework network; and
second-level micropores, formed inside a material of the framework network.

In some implementations, the first-level micropores are at least partially configured to provide channels for allowing the e-liquid matrix to flow in the porous body.

In some implementations, the second-level micropores are at least partially configured to reduce transfer of heat from the heating element to the framework network or the porous body.

In some implementations, the first-level micropores and the second-level micropores are basically not connected;
and/or, the first-level micropores and the second-level micropores are basically separated or isolated by the surface of the framework network.

In some implementations, the first-level micropores are basically connected to each other in the framework network.

In some implementations, the second-level micropores are basically separated or discretely arranged inside the material of the framework network.

In some implementations, the first-level micropores are basically open pores; or, a quantity of the open pores in the first-level micropores is greater than a quantity of closed pores.

In some implementations, the second-level micropores are basically closed pore; or, a quantity of the closed pores in the second-level micropores is greater than a quantity of open pores.

In some implementations, the first-level micropores in the porous body are basically uniformly distributed in the whole porous body.

In some implementations, the framework network is crosslinked in a three-dimensional mesh manner.

In some implementations, the first-level micropores are detected by a mercury intrusion method;
and/or, the existence of the second-level micropores is undetected by a mercury intrusion method.

In the above atomizer, the porous body has higher absorption and transfer efficiency on the e-liquid matrix.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic atomization device according to an embodiment;

FIG. 2 is a schematic diagram of a specific embodiment of an atomizer in FIG. 1;

FIG. 3 is a schematic diagram of an embodiment of an atomization assembly in FIG. 2;

FIG. 4 is a schematic diagram of another specific embodiment of an atomizer in FIG. 1;

FIG. 5 is a schematic diagram of a preparation method of a porous body according to an embodiment;

FIG. 6 is a cross-sectional view, scanned by an electron microscope at a magnification factor, of a porous body according to an embodiment;

FIG. 7 is a cross-sectional view, scanned by an electron microscope at another magnification factor, of the porous body in FIG. 6;

FIG. 8 is a cross-sectional view, scanned by an electron microscope at a magnification factor, of a porous body in a comparative example;

FIG. 9 is a cross-sectional view, scanned by an electron microscope at another magnification factor, of the porous body in the comparative example in FIG. 8;

FIG. 10 is a cross-sectional view, scanned by an electron microscope at a magnification factor, of a porous body in another comparative example;

FIG. 11 is a comparison diagram of distributions of pore diameters, measured by a mercury intrusion method, of a porous body of an embodiment and a porous body of a comparative example;

FIG. 12 is a comparison diagram of test results of absorption rates of a porous body of an embodiment and a porous body of a comparative example on an e-liquid matrix;

FIG. 13 is a comparison diagram of test results of absorption rates of a porous body of another embodiment and a porous body of a comparative example on an e-liquid matrix;

FIG. 14 is a schematic diagram of a porous body according to an embodiment after the porous body is damaged in a strength test;

FIG. 15 is a schematic diagram of a porous body according to a comparative example after the porous body is damaged in a strength test;

FIG. 16 is a schematic structural diagram of an atomization assembly according to another embodiment;

FIG. 17 is a schematic cross-sectional view of the atomization assembly in FIG. 16 from an angle;

FIG. 18 is a surface appearance diagram of an atomization assembly according to an embodiment;

FIG. 19 is a cross-sectional appearance diagram of the atomization assembly in FIG. 18 from an angle;

FIG. 20 is a cross-sectional view, scanned by an electron microscope at a magnification factor, of the atomization assembly in FIG. 18;

FIG. 21 is a cross-sectional appearance diagram of an atomization assembly according to another embodiment from an angle;

FIG. 22 is a cross-sectional view, scanned by an electron microscope at a magnification factor, of a porous body according to another embodiment;

FIG. 23 is a schematic diagram of preparing a large number of porous bodies by using a porous gel body formed by a mold according to an embodiment;

FIG. 24 is a diagram, scanned by an electron microscope, of a surface of a porous body according to an embodiment;

FIG. 25 is a cross-sectional view, scanned by an electron microscope at a magnification factor, of a porous body according to an embodiment;

FIG. 26 is a cross-sectional view, scanned by an electron microscope at another magnification factor, of the porous body in FIG. 25;

FIG. 27 is a schematic diagram of an atomization assembly according to another embodiment; and

FIG. 28 is a schematic diagram of an atomization assembly according to another embodiment.

### DETAILED DESCRIPTION

For ease of understanding of the present application, the present application is described below in more detail with reference to accompanying drawings and specific implementations.

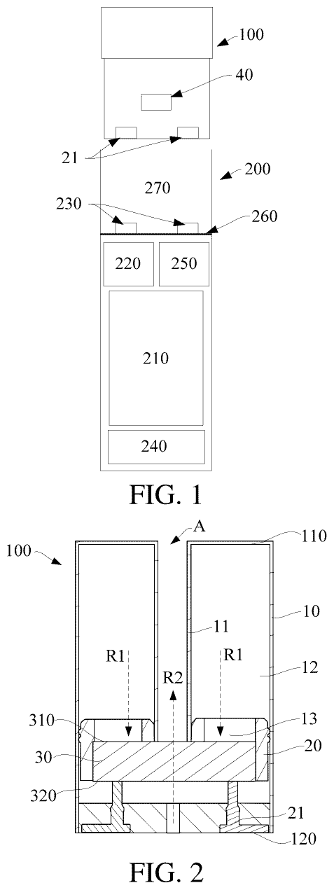

The present application provides an electronic atomization device. Referring to FIG. 1, the electronic atomization device includes: an atomizer 100 which stores an e-liquid matrix and atomizes the e-liquid matrix to generate an aerosol; and a power supply assembly 200 for supplying power to the atomizer 100.

In an optional implementation, for example, as shown in FIG. 1, the power supply assembly 200 includes: a receiving cavity 270 arranged on an end in a length direction and configured to receive and accommodate at least part of an atomizer 100; and an electrical contact 230 at least partially exposed out of a surface of the receiving cavity 270 and configured to supply power to the atomizer 100 when at least part of the atomizer 100 is received and accommodated in the power supply assembly 200.

According to the implementation shown in FIG. 1, an electrical contact 21 is arranged on an end portion of the atomizer 100 opposite to the power supply assembly 200 in the length direction, so that when at least part of the atomizer 100 is received in the receiving cavity 270, the electrical contact 21 is in contact with and abuts against the electrical contact 230 to conduct electricity.

A seal member 260 is arranged in the power supply assembly 200, and at least part of an internal space of the power supply assembly 200 is separated through the seal member 260 to form the receiving cavity 270. In the implementation shown in FIG. 1, the seal member 260 is constructed to extend in a cross-sectional direction of the power supply assembly 200, and is preferably made by a flexible material, to prevent the e-liquid matrix seeping from the atomizer 100 to the receiving cavity 270 from flowing to a controller 220, a sensor 250, and other components inside the power supply assembly 200.

In the implementation shown in FIG. 1, the power supply assembly 200 further includes a battery cell 210, arranged facing away from the receiving cavity 270 in the length direction and configured to supply power; and the controller 220, arranged between the battery cell 210 and the receiving cavity 270, where the controller 220 operably guides a current between the battery cell 210 and the electrical contact 230.

During use, the power supply assembly 200 includes the sensor 250, configured to sense an inhalation flow generated by the atomizer 100 during inhalation, so that the controller 220 controls the battery cell 210, based on a detection signal of the sensor 250, to output a current to the atomizer 100.

Further, In the implementation shown in FIG. 1, a charging interface 240 is arranged on the other end of the power supply assembly 200 facing away from the receiving cavity 270, and is configured to supply power to the battery cell 210.

An embodiment of FIG. 2 shows a schematic structural diagram of the atomizer 100 in FIG. 1 according to an embodiment. The atomizer 100 includes:
a main housing 10. As shown in FIG. 2, the main housing 10 is approximately in a lengthwise cylindrical shape. Certainly, an interior of the main housing 10 is a hollow necessary functional component configured to store and atomize an e-liquid matrix. The main housing 10 has a near end 110 and a far end 120 opposite each other in the length direction. Based on a common use demand, the near end 110 is configured as an aerosol inhalation end for a user, and a suction nozzle A for inhalation by the user is arranged on the near end 110. The far end 120 is used as one end to which the power supply assembly 200 is bonded.

Further, referring to FIG. 2, an e-liquid storage cavity 12 for storing the e-liquid matrix and an atomization assembly configured to absorb the e-liquid matrix from the e-liquid storage cavity 12 and heat and atomize the e-liquid matrix is arranged inside the main housing 10. In the schematic diagram shown in FIG. 2, an aerosol conveying tube 11 is arranged in the main housing 10 in an axial direction, and the e-liquid storage cavity 12 for storing the e-liquid matrix is formed in a space between the aerosol conveying tube 11 and an inner wall of the main housing 10. A first end of the aerosol conveying tube 11 opposite to the near end 110 is communicated to the suction nozzle A, to output the aerosol generated by the atomization assembly through atomization to the suction nozzle A for inhalation.

Further, in some optional implementations, the aerosol conveying tube 11 and the main housing 10 are integrally formed by using a mouldable material, so that the e-liquid storage cavity 12 formed after the preparation is opened or opened toward the far end 120.

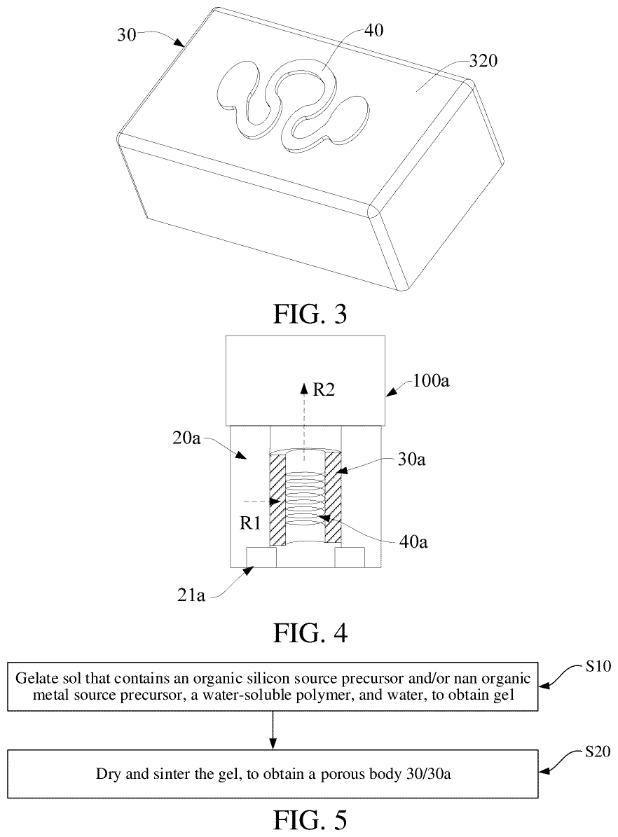

Further referring to FIG. 2 and FIG. 3, the atomizer 100 further includes an atomization assembly configured to atomize at least part of the e-liquid matrix to generate an aerosol. Specifically, the atomization assembly includes:
a porous body 30, and a heating element 40 for absorbing the e-liquid matrix from the porous body 30 and heating and evaporating the e-liquid matrix. In addition, in some implementations, the porous body 30 may be made of a rigid capillarity element such as porous ceramic, porous glass ceramic, or porous glass. Alternatively, in some other implementations, the porous body 30 includes a capillarity element that has a capillary channel inside and can absorb and transfer the e-liquid matrix.

The atomization assembly is contained and kept in a flexible seal element 20 such as silicon gel, and the porous body 30 of the atomization assembly is in fluid connection with the e-liquid storage cavity 12 through an e-liquid guide channel 13 defined by the seal element 20 to receive the e-liquid matrix. During use, in a direction indicated by the arrow R1 in FIG. 2, e-liquid in the e-liquid storage cavity 12 flows to the atomization assembly through the e-liquid guide channel 13, and is absorbed and heated. Then, the generated aerosol is output to the suction nozzle A through the aerosol conveying tube 11 and is inhaled by a user in a direction indicated by the arrow R2 in FIG. 2.

Further referring to FIG. 2 to FIG. 3, specific structures of the atomization assembly include:
a porous body 30, having a surface 310 and a surface 320 facing away from the surface 310, namely, a first surface 310 and a second surface 320. After assembling, the surface 310 faces the e-liquid storage cavity 12, and is in fluid connection to the e-liquid storage cavity 12 through the e-liquid guide channel 13, so as to absorb the e-liquid matrix. The surface 320 faces away from the e-liquid storage cavity 12. Namely, the porous body 30 includes a first surface 310, configured to be in fluid connection to the e-liquid storage cavity 12 to receive the e-liquid matrix from the e-liquid storage cavity 12.

In some embodiments, the porous body 30 includes porous ceramic, porous glass, and the like. The porous body 30 has a large number of micropores inside, so as to absorb and transfer the e-liquid matrix through the micropores inside.

In this embodiment, the porous body 30 is approximately sheetlike, plate-like, or block-shaped, and two surfaces that are opposite to each other in a thickness direction are respectively used as the surface 310 for absorbing the e-liquid matrix and the surface 320 for heating and atomization. Alternatively, in more embodiments, the porous body 30 may have more shapes, such as an arch shape, a cup shape, and a groove shape. Alternatively, for example, in Chinese Patent Application No. CN215684777U, the applicants have provided configuration details about a shape of an arch-shaped porous body having an inner channel and about absorption and atomization of an e-liquid matrix by the porous body, which is incorporated by reference in its entirety.

In an implementation, the surface 320 has a length size of about 6 to 15 mm and a width size of about 3 to 6 mm.

In an embodiment, the surface 320 of the porous body 30 is flat. The heating element 40 may be bonded to the surface 320 of the porous body 30 by printing, deposition, coating, mounting, welding, mechanical fixing, slurry sintering, or the like. Alternatively, in some changed embodiments, the surface 310 and/or the surface 320 of the porous body 30 is non-flat. For example, the surface 310 and/or the surface 320 is curved, or the surface 310 and/or the surface 320 is a surface having a groove or protrusion structure. Namely, the porous body 30 includes a second surface 320, and the heating element 40 is at least partially arranged on the second surface 320.

Alternatively, in some changed embodiments, the porous body 30 has more surfaces or side surfaces, so that the porous body is in fluid connection to the e-liquid storage cavity 12 to absorb the e-liquid matrix through these surfaces or side surfaces. In addition, or in still other embodiments, the heating element 40 may be formed on a plurality of surfaces or side surfaces, to atomize the e-liquid matrix on the plurality of surfaces to generate an aerosol.

Alternatively, FIG. 4 shows a schematic diagram of an atomizer 100a according to another changed embodiment. In the atomizer 100a of this embodiment:

The porous body 30a is configured in a shape of a hollow column extending in a longitudinal direction of the atomizer 100a, and the heating element 40a is formed in the column hollow of the porous body 30a. During use, in the direction indicated by the arrow R1, the e-liquid matrix of the e-liquid storage cavity 20a is absorbed along an outer surface in a radial direction of the porous body 30a, and then transferred to the heating element 40a on an inner surface and heated and evaporated to generate an aerosol. The generated aerosol is outputted from the column hollow interior of the porous body 30a in the longitudinal direction of the atomizer 100a. Two ends of the heating element 40a are electrically connected to electrical contacts 21a through leads.

In some typical implementations, the heating element 40/40a may have an initial resistance value of about 0.3Ω to 1.5Ω.

An embodiment of the present application provides a preparation method for preparing the above porous body 30/30a. Referring to FIG. 5, the preparation method includes the following steps:

S10, sol that contains silicon and/or a metal is gelated to obtain gel. The sol that contains the silicon and/or the metal includes a silicon source precursor and/or a metal source precursor, a water-soluble polymer, and a solvent.

S20: The gel is sintered after being cut, washed, and dried, to obtain the porous body 30/30a.

The foregoing term “gelate” is a term in the field of inorganic chemistry, and means a process of aging the sol to slowly aggregate sol particles to form elastic gel having a three-dimensional crosslinked meshed framework structure, and the generated gel network is full of a solvent that loses fluidity.

In the above preparation, during the formation of the ceramic precursor of the silicon and/or the metal, the silicon source precursor is added in the form of an organic silicon source precursor. The metal source precursor may include organic alkoxide of the metal and inorganic salt of the metal. The raw materials of the silicon source precursor and/or the metal source precursor are uniformly mixed in a liquid phase for hydrolysis and chemical condensation reaction, to form a stable sol system in the solution. Then, the sol system is gelated, dried, and sintered to obtain the ceramic body 30/30a.

Based on the ceramic porous body 30/30a to be prepared, the metal in the metal precursor may correspondingly include at least one of: zircon, aluminum, titanium, calcium, iron, and the like.

Correspondingly, in this implementation, the organic silicon source precursor includes methyl orthosilicate, ethyl orthosilicate, methyl trimethoxy-silane, methyl trihexaoxy-silane, silicon-containing alkane or ester, and a derivative. The metal source precursor may usually include an organic alkoxide of the metal, such as isopropyl titanate and zirconium n-propoxide. The inorganic salt of the metal may include titanyl sulfate, zirconium oxychloride, aluminum chloride, and the like.

The water-soluble polymer is a high-polymer organic matter for assisting in aging during gelation. Usually, during the gelation, such a water-soluble polymer includes, for example, a polyethylene glycol, polyacrylamide, and polyvinylpyrrolidone.

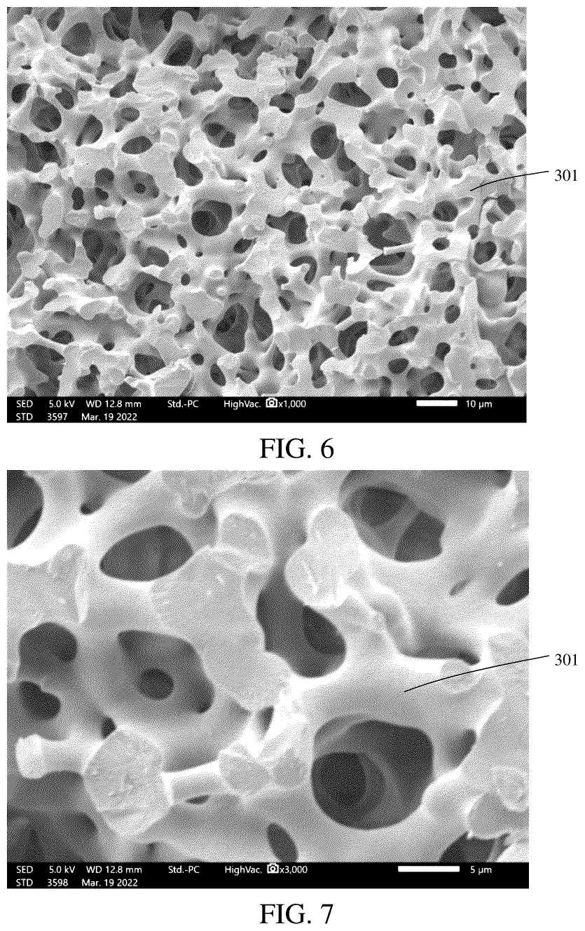

During the preparation: Pores of the porous body 30/30a are defined by a space occupied by the solvent that loses fluidity in the gel. In addition, in the drying process, the sol in the gel is volatilized, decomposed, or the like, so that an originally occupied space is released to form porous dry gel. Then, the dry gel is sintered, so that a crosslinked gel framework network 301 is formed into a ceramic framework of the porous body 30/30a, and the space originally occupied by the solvent is formed into micropores in the framework. Referring to FIG. 6, FIG. 6 is a cross-sectional view, scanned by an electron microscope at a magnification factor, of a porous body 30/30a according to an embodiment. In this figure, the framework network 301 is formed into a framework of the porous body 30/30a.

In some embodiments, a method for preparing a silicon dioxide porous body 30/30a includes:

S10, dilute nitric acid with a pH value of 0 is prepared using concentrated nitric acid and deionized water; 0.01 to 3 grams of polyethylene glycol (with a molecular weight of 200 to 1 million) is added and is stirred until the polyethylene glycol is uniformly dispersed; 20 to 40 mmol of ethyl orthosilicate is added; the mixture is continued to be stirred uniformly to form silica sol; after the sol is clarified, the sol is injected into a mold; and the mold is sealed and placed at 40° for gelation.

S20, after gel is obtained in step S10, the silicon dioxide porous body 30/30a can be obtained by cutting, washing, drying, and sintering the gel. In the sintering process, a heating rate should not exceed 100 per minute. The temperature is maintained for 1 hour or longer after reaching a target temperature of 10000. The gel is cooled after being sintered.

In a specific embodiment, a method for preparing a porous body 30/30a containing Si—Ti ceramic includes:

S10, dilute nitric acid with a pH value of 0 and a volume of 9 mm is prepared using concentrated nitric acid and deionized water; 0.01 to 3 grams of polyethylene glycol (with a molecular weight of 200 to 1 million) is added and is stirred until the polyethylene glycol is uniformly dispersed; 25 mmol of ethyl orthosilicate is added; after the mixture is continued to be stirred for 30 minutes, the solution is put into an ice-water bath for cooling; 10 mmol of ethyl acetoacetate and 5 mmol of isopropyl titanate are added in sequence; the mixture is continued to be stirred uniformly to form sol that contains silicon and titanium; the sol is injected into a mold, and the container is sealed for standing still at 40°; and after 24 hours, wet gel can be obtained.

S20, the wet gel is washed, dried, and sintered to obtain the porous body 30/30a containing Si—Ti ceramic. In the sintering process, a heating rate is 8° per minute. The temperature is maintained for 2 hours after reaching a target temperature of 12000. The gel is cooled after being sintered.

In a specific embodiment, a method for preparing a porous body 30/30a containing Si—Zr ceramic includes:

S10, dilute nitric acid with a pH value of 0 and a volume of 9 mm is prepared using concentrated nitric acid and deionized water; 0.01 to 3 grams of polyethylene glycol (with a molecular weight of 200 to 1 million) is added and is stirred until the polyethylene glycol is uniformly dispersed; 25 mmol of ethyl orthosilicate is added; after the mixture is continued to be stirred for 30 minutes, the solution is put into an ice-water bath for cooling; 5 mmol of zirconium n-propoxide is then added; after the mixture is continued to be stirred for 5 minutes, sol that contains silicon and zirconium is formed; a stirrer is taken out, and the container is sealed for standing still at 400; and wet gel can be obtained after 24 hours.

S20, the wet gel is washed, dried, and sintered to obtain the porous body 30/30a containing Si—Zr ceramic. In the sintering process, a heating rate is 4° per minute. The temperature is maintained for 2 hours after reaching a target temperature of 1000°. The gel is cooled after being sintered.

In some embodiments, a solvent for the sol that contains silicon and/or metal is mainly water. Or, a mixed solvent formed by adding at least one organic solvent such as methanol, ethanol, formamide, and dimethylformamide can be added into water can be used.

In some embodiments, the water-soluble polymer includes but is not limited to: at least one of polyethylene glycol, polyacrylic acid, polyacrylamide, and the like. In some other embodiments, no water-soluble polymer may be used.

In some embodiments, at least one of nitric acid, hydrochloric acid, acetic acid, and the like is used as a catalyst for sol gelation.

In some embodiments, a volume of the generated gel is finally adjusted by changing the amount of the solvent in the sol, the amounts of the reactants, the amount of the water-soluble polymer, and the like, so that a void ratio of the finally generated porous body 30/30a and a pore diameter of each micropore are adjustable.

In some embodiments, the void ratio of the porous body 30/30a formed by sintering gel is 55 to 80%.

In addition, in some embodiments, the micropore diameter of each micropore in the porous body 30/30a formed by sintering gel is adjustable in a range of 0.3 to 50 micrometers.

In addition, in some embodiments, the sol or the gel contains less than three types of oxides that contains silicon and metal. The components of the prepared porous body 30/30a is pure. For example, it is advantageous to improve the compatibility if the porous body 30/30a contains less than three types of oxides with the mass percentage exceeding 5%. For example, if the mass percentage of the silicon dioxide in the porous body 30/30a prepared in the above implementation is greater than 95%. Alternatively, the porous body 30/30a prepared after the silica sol is gelated is pure porous silicon dioxide.

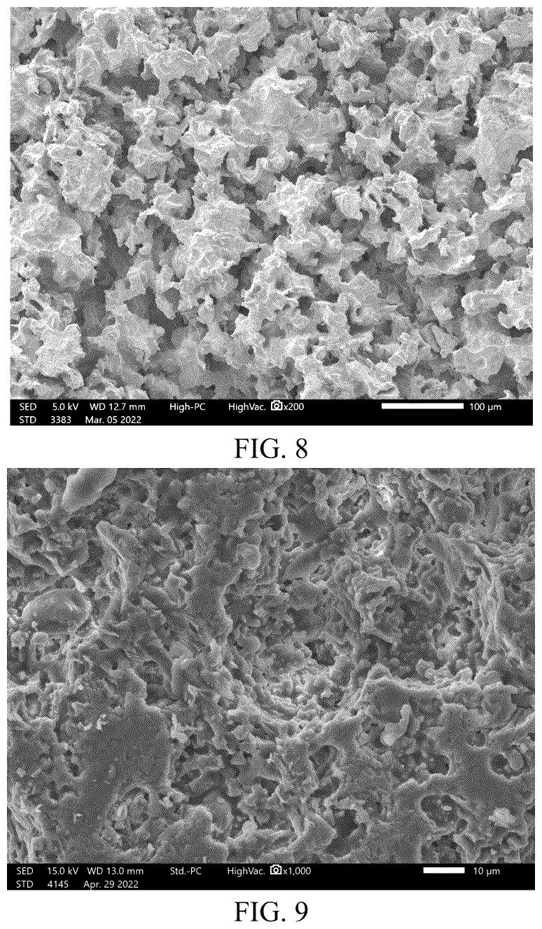

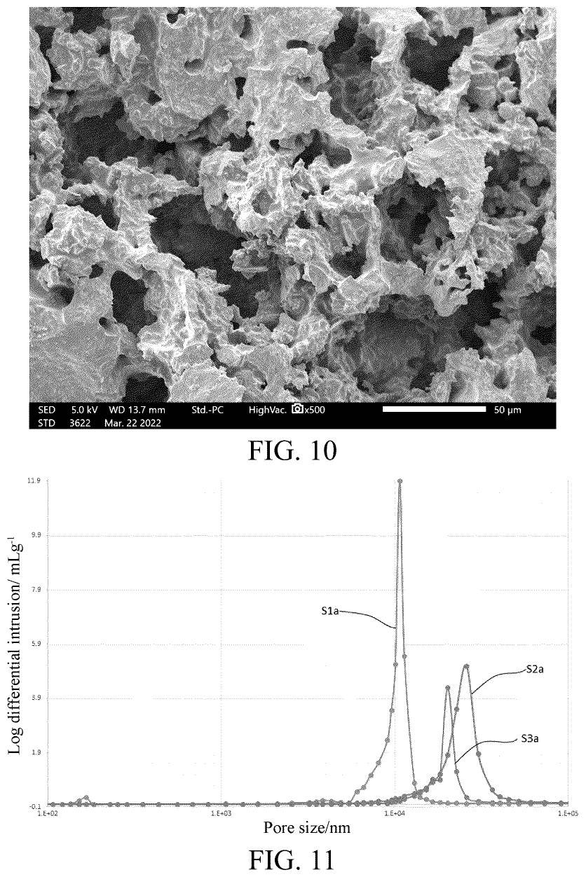

In addition, in some embodiments, for example, FIG. 6 and FIG. 7 show cross-sectional views, scanned by an electron microscope at different magnification factors, of porous bodies 30 that are sintered after silica sol prepared from ethyl orthosilicate in an embodiment. Correspondingly, FIG. 8 and FIG. 9 show cross-sectional views, scanned by an electron microscope at different magnification factors, of porous bodies that are sintered after mixing silicon dioxide and commonly used PMMA microsphere pore-forming material and have the same sizes in the comparative example 1. FIG. 10 shows a cross-sectional view, scanned by an electron microscope, of a porous body that is sintered after mixing silicon dioxide, zirconium dioxide, and a pore-forming material graphite powder and has basically the same size in the comparative example 2.

In the cross-sectional appearance of the porous body 30 prepared in the embodiments shown in FIG. 6 and FIG. 7, the micropores in the porous body 30 are basically three-dimensionally connected or co-continuous. Moreover, the micropores in the porous body 30 are basically uniformly distributed in the porous body 30.

In the cross-sectional morphology of the porous bodies in the comparative examples from FIG. 8 to FIG. 10, the micropores in the porous bodies prepared in the comparative examples are not co-continuous. In addition, the distribution of the micropores in the porous bodies prepared in the comparative examples is obviously not uniform.

FIG. 11 shows the porous bodies 30 prepared in two embodiments of the present application, and the porous bodies prepared in the comparative examples of FIG. 8 and FIG. 9. A pore size diameter-log differential intrusion, also referred to as a comparison diagram of a distribution relationship between a volume and a pore diameter, is measured using a mercury intrusion method according to the national standard GB/T 21650.1-2008. Curve S1a in FIG. 11 is a pore diameter distribution curve of a porous body 30 with a small median pore diameter (also referred to as an average pore diameter, which represents a corresponding pore diameter when a cumulative pore diameter distribution percentage of a sample reaches 50%, usually denoted as D50) in an embodiment; curve S2a in FIG. 11 is a pore diameter distribution curve of a porous body 30 with a large median pore diameter in an embodiment; and curve S3a in FIG. 11 is a pore diameter distribution curve of a porous body prepared by sintering a pore-forming material in a comparative example.

In addition, test results of the national standard mercury intrusion method for the median pore diameters and void ratios of the porous bodies 30 prepared in the two embodiments in FIG. 11, and the median pore diameter and void ratio of the porous body prepared in the comparative example are shown in the following table:

| | Median pore diameter/μm | Void ratio |
|---|---|---|
| Embodiment 1/S1a | 10.9 | 66.9% |
| Embodiment 2/S2a | 26.5 | 63.2% |
| Comparative example 1/S3a | 21.3 | 54.2% |

Further, for data of pore diameter distribution inside the porous body 30 prepared in Embodiment 1, which is measured by the “mercury intrusion method and gas absorption method of the national standard GB/T 21650.1-2008 for measuring a pore diameter distribution and void ratio of a solid material”, refer to the following table:

| Mercury | | Volume | Difference % from | Ratio % of pore |
|---|---|---|---|---|
| injection | Pore diameter | proportion % in | a ratio of a previous | diameters in each |
| pressure (psia) | range (nm) | all micropores | pore diameter range | section |
| 0.52 | >349240.5 | 0.0000 | 0.00 | 2.20 |
| 0.64 | >281880.3 | 0.0020 | 0.20 | |
| 0.76 | >238098.7 | 0.0034 | 0.14 | |
| 0.89 | >203539.8 | 0.0046 | 0.12 | |
| 0.96 | >189007.2 | 0.0049 | 0.03 | |
| 1.02 | >177824.3 | 0.0054 | 0.04 | |
| 1.24 | >145448.4 | 0.0071 | 0.18 | |
| 1.49 | >121303.4 | 0.0082 | 0.11 | |
| 2.00 | >90574.1 | 0.0099 | 0.17 | |
| 2.49 | >72634.1 | 0.0114 | 0.14 | |
| 2.99 | >60467.3 | 0.0127 | 0.13 | |
| 3.49 | >51811.7 | 0.0135 | 0.09 | |
| 3.99 | >45331 | 0.0145 | 0.10 | |
| 4.49 | >40290.6 | 0.0152 | 0.07 | |
| 4.99 | >36264.7 | 0.0161 | 0.09 | |
| 5.99 | >30210.5 | 0.0185 | 0.25 | |
| 6.98 | >25898.8 | 0.0199 | 0.14 | |
| 7.98 | >22672.2 | 0.0220 | 0.21 | |
| 8.98 | >20141.2 | 0.0240 | 0.20 | 69.19 |
| 9.98 | >18131.6 | 0.0264 | 0.25 | |
| 10.97 | >16481.7 | 0.0297 | 0.32 | |
| 11.97 | >15110.6 | 0.0357 | 0.60 | |
| 12.97 | >13948.9 | 0.0434 | 0.77 | |
| 13.96 | >12953.3 | 0.0649 | 2.14 | |
| 15.95 | >11336.7 | 0.3332 | 26.83 | |
| 16.95 | >10669 | 0.6001 | 26.69 | |
| 17.99 | >10052.5 | 0.7132 | 11.31 | 25.84 |
| 18.99 | >9524.3 | 0.7819 | 6.88 | |
| 19.99 | >9049.5 | 0.8265 | 4.45 | |
| 22.47 | >8049.2 | 0.8924 | 6.59 | |
| 24.96 | >7245.5 | 0.9337 | 4.13 | |
| 27.46 | >6586.6 | 0.9554 | 2.17 | |
| 29.98 | >6032.7 | 0.9705 | 1.51 | |
| 32.33 | >5594.1 | 0.9715 | 0.10 | |
| 36.51 | >4953.8 | 0.9742 | 0.27 | 2.85 |
| 41.55 | >4353.4 | 0.9799 | 0.57 | |
| 47.50 | >3807.4 | 0.9869 | 0.70 | |
| 51.97 | >3480 | 0.9902 | 0.33 | |
| 56.48 | >3202.2 | 0.9923 | 0.20 | |
| 71.52 | >2528.7 | 0.9964 | 0.42 | |
| 86.93 | >2080.6 | 0.9975 | 0.11 | |
| 112.39 | >1609.2 | 0.9986 | 0.11 | |
| 137.08 | >1319.4 | 0.9991 | 0.04 | |
| 172.28 | >1049.8 | 1.0000 | 0.09 | |
| 216.62 | >834.9 | 1.0000 | 0.00 | |
| 266.40 | >678.9 | 1.0000 | 0.00 | |
| 327.19 | >552.8 | 1.0000 | 0.00 | |
| 417.70 | >433 | 1.0000 | 0.00 | |
| 517.58 | >349.4 | 1.0000 | 0.00 | |
| 637.87 | >283.5 | 1.0000 | 0.00 | |
| 717.58 | >252 | 1.0000 | 0.00 | |
| 797.80 | >226.7 | 1.0000 | 0.00 | |
| 987.49 | >183.2 | 1.0000 | 0.00 | |

According to the test data of the above mercury intrusion method, a proportion of the micropores having pore diameters of 5 micrometers to 20 micrometers in the porous body 30 prepared in Embodiment 1 to all the micropores is basically 95%. It is greater than 90%. In addition, a proportion of micropores having pore diameters less than 5 micrometers in the porous body 30 prepared in Embodiment 1 to all the micropores is less than 3%. In addition, a proportion of micropores having pore diameters greater than 20 micrometers in the porous body 30 prepared in Embodiment 1 to all the micropores is less than 3%.

Further, for data of pore diameter distribution inside the porous body 30 prepared in Embodiment 2, which is measured by the “mercury intrusion method and gas absorption method of the national standard GB/T 21650.1-2008 for measuring a pore diameter distribution and void ratio of a solid material”, refer to the following table:

| Mercury | | Volume | Difference % from | Ratio % of pore |
|---|---|---|---|---|
| injection | Pore diameter | proportion % in | a ratio of a previous | diameters in each |
| pressure (psia) | range (nm) | all micropores | pore diameter range | section |
| 0.52 | >348781.3 | 0.0000 | 0.00 | 2.21 |
| 0.64 | >281125.9 | 0.0043 | 0.43 | |
| 0.76 | >237211.8 | 0.0072 | 0.29 | |
| 0.89 | >203158.9 | 0.0099 | 0.27 | |
| 0.96 | >188646.3 | 0.0112 | 0.13 | |
| 1.02 | >177324.9 | 0.0123 | 0.11 | |
| 1.24 | >145360.6 | 0.0178 | 0.56 | |
| 1.49 | >121311.2 | 0.0221 | 0.43 | |
| 2.00 | >90490.2 | 0.0279 | 0.58 | 4.78 |
| 2.49 | >72555.8 | 0.0341 | 0.62 | |
| 2.99 | >60439.2 | 0.0396 | 0.55 | |
| 3.49 | >51824.4 | 0.0468 | 0.72 | |
| 3.99 | >45304.3 | 0.0570 | 1.01 | |
| 4.49 | >40298.8 | 0.0699 | 1.29 | |
| 4.99 | >36267.6 | 0.0927 | 2.29 | 84.96 |
| 5.99 | >30215.2 | 0.2293 | 13.65 | |
| 6.99 | >25892 | 0.5461 | 31.69 | |
| 7.98 | >22665.4 | 0.7336 | 18.74 | |
| 8.98 | >20133.8 | 0.8204 | 8.68 | |
| 9.98 | >18127.6 | 0.8670 | 4.66 | |
| 10.97 | >16481.8 | 0.8982 | 3.12 | |
| 11.97 | >15105.6 | 0.9195 | 2.13 | |
| 12.97 | >13948.1 | 0.9347 | 1.51 | 5.32 |
| 13.96 | >12951.8 | 0.9465 | 1.18 | |
| 15.96 | >11334.1 | 0.9631 | 1.66 | |
| 16.96 | >10662.1 | 0.9680 | 0.49 | |
| 17.95 | >10074 | 0.9728 | 0.47 | |
| 18.99 | >9522.7 | 0.9766 | 0.38 | 2.72 |
| 19.99 | >9047.7 | 0.9786 | 0.20 | |
| 22.47 | >8048.8 | 0.9842 | 0.56 | |
| 24.97 | >7243.3 | 0.9872 | 0.30 | |
| 27.46 | >6585.5 | 0.9898 | 0.26 | |
| 29.96 | >6037.2 | 0.9912 | 0.14 | |
| 32.02 | >5648.4 | 0.9921 | 0.09 | |
| 36.63 | >4937.4 | 0.9930 | 0.09 | |
| 41.23 | >4386.6 | 0.9940 | 0.09 | |
| 46.51 | >3888.3 | 0.9948 | 0.08 | |
| 51.90 | >3484.7 | 0.9960 | 0.12 | |
| 56.74 | >3187.5 | 0.9967 | 0.07 | |
| 70.78 | >2555.5 | 0.9970 | 0.03 | |
| 86.86 | >2082.3 | 0.9979 | 0.08 | |
| 111.90 | >1616.2 | 0.9984 | 0.06 | |
| 136.38 | >1326.2 | 0.9990 | 0.06 | |
| 171.60 | >1054 | 0.9990 | 0.00 | |
| 217.03 | >833.3 | 0.9994 | 0.05 | |
| 267.84 | >675.3 | 0.9996 | 0.02 | |
| 326.34 | >554.2 | 0.9998 | 0.02 | |
| 416.78 | >434 | 1.0000 | 0.02 | |
| 517.02 | >349.8 | 1.0000 | 0.00 | |
| 636.91 | >284 | 1.0000 | 0.00 | |
| 717.14 | >252.2 | 1.0000 | 0.00 | |
| 797.43 | >226.8 | 1.0000 | 0.00 | |
| 986.84 | >183.3 | 1.0000 | 0.00 | |

According to the test data of the above mercury intrusion method, a proportion of the micropores having pore diameters of 15 micrometers to 36 micrometers in the porous body 30 prepared in Embodiment 2 to all the micropores is basically 84.96%. It is greater than 80%. In addition, a proportion of micropores having pore diameters less than 15 micrometers in the porous body 30 prepared in Embodiment 2 to all the micropores is less than 10%. In addition, a proportion of micropores having pore diameters greater than 36 micrometers in the porous body 30 prepared in Embodiment 1 to all the micropores is less than 10%.

Further, for data of pore diameter distribution inside the porous body prepared in the comparative example 1, which is measured by the “mercury intrusion method and gas absorption method of the national standard GB/T 21650.1-2008 for measuring a pore diameter distribution and void ratio of a solid material”, refer to the following table:

| Mercury | | Volume | Difference % from | Ratio % of pore |
|---|---|---|---|---|
| injection | Pore diameter | proportion % in | a ratio of a previous | diameters in each |
| pressure (psia) | range (nm) | all micropores | pore diameter range | section |
| 0.52 | >347532.0 | 0.0000 | 0.000 | 6.159 |
| 0.64 | >281160.5 | 0.0072 | 0.715 | |
| 0.76 | >236906.2 | 0.0123 | 0.517 | |
| 0.89 | >202711.6 | 0.0161 | 0.378 | |
| 0.96 | >188467.2 | 0.0183 | 0.219 | |
| 1.02 | >177362.9 | 0.0201 | 0.179 | |
| 1.25 | >145156.0 | 0.0280 | 0.795 | |
| 1.49 | >121124.7 | 0.0332 | 0.517 | |
| 2.00 | >90444.9 | 0.0427 | 0.954 | |
| 2.50 | >72483.7 | 0.0495 | 0.676 | |
| 2.99 | >60396.1 | 0.0556 | 0.616 | |
| 3.49 | >51806.0 | 0.0616 | 0.596 | |
| 3.99 | >45312.9 | 0.0664 | 0.477 | 3.378 |
| 4.49 | >40250.6 | 0.0719 | 0.556 | |
| 4.99 | >36243.6 | 0.0777 | 0.576 | |
| 5.99 | >30205.2 | 0.0954 | 1.768 | |
| 6.99 | >25891.8 | 0.1295 | 3.417 | 76.817 |
| 7.98 | >22657.8 | 0.2680 | 13.849 | |
| 8.98 | >20135.6 | 0.7042 | 43.612 | |
| 9.98 | >18123.2 | 0.7872 | 8.305 | |
| 10.98 | >16476.6 | 0.8635 | 7.630 | |
| 11.97 | >15104.5 | 0.9032 | 3.974 | 12.14 |
| 12.97 | >13942.5 | 0.9326 | 2.941 | |
| 13.97 | >12946.9 | 0.9525 | 1.987 | |
| 15.96 | >11333.2 | 0.9744 | 2.186 | |
| 16.96 | >10664.9 | 0.9801 | 0.576 | |
| 17.95 | >10073.3 | 0.9849 | 0.477 | |
| 18.96 | >9539.2 | 0.9883 | 0.338 | 1.510 |
| 19.96 | >9062.0 | 0.9897 | 0.139 | |
| 22.48 | >8046.3 | 0.9936 | 0.397 | |
| 24.97 | >7242.8 | 0.9960 | 0.238 | |
| 27.47 | >6584.2 | 0.9976 | 0.159 | |
| 29.96 | >6036.6 | 0.9976 | 0.000 | |
| 33.29 | >5433.6 | 1.0000 | 0.238 | |
| 37.31 | >4848.1 | 1.0000 | 0.000 | |
| 42.11 | >4294.8 | 1.0000 | 0.000 | |
| 47.28 | >3825.0 | 1.0000 | 0.000 | |
| 51.28 | >3527.1 | 1.0000 | 0.000 | |
| 56.31 | >3212.0 | 1.0000 | 0.000 | |
| 71.35 | >2535.0 | 1.0000 | 0.000 | |
| 86.67 | >2086.7 | 1.0000 | 0.000 | |
| 111.47 | >1622.5 | 1.0000 | 0.000 | |
| 136.52 | >1324.8 | 1.0000 | 0.000 | |
| 171.77 | >1052.9 | 1.0000 | 0.000 | |
| 216.21 | >836.5 | 1.0000 | 0.000 | |
| 266.90 | >677.6 | 1.0000 | 0.000 | |
| 326.74 | >553.5 | 1.0000 | 0.000 | |

Further, from the microstructure of the porous body 30 of the embodiment shown in FIG. 6/FIG. 7 and the microstructure of the porous body of the comparative example shown in FIG. 8/FIG. 9/FIG. 10, it can be seen that a surface of a ceramic three-dimensional framework of the porous body 30 prepared in the embodiment is smooth. Apparently, a surface of a ceramic framework of the ceramics of the comparative example is relatively rough. Further, the e-liquid matrix flows in the micropores of the porous body 30 having the smooth framework surface more smoothly or with less resistance. Thus, it is advantageous to improve the transfer efficiency of the e-liquid matrix.

The smooth surface of the three-dimensional framework of the above porous body 30 is observed and measured in an electron microscope, and is specifically tested by the electron microscope at a factor of 500 or a larger factor. For example, in FIG. 6, the magnification factor of the electron microscope is 1000, and in FIG. 7, the magnification factor of the electron microscope is 3000.

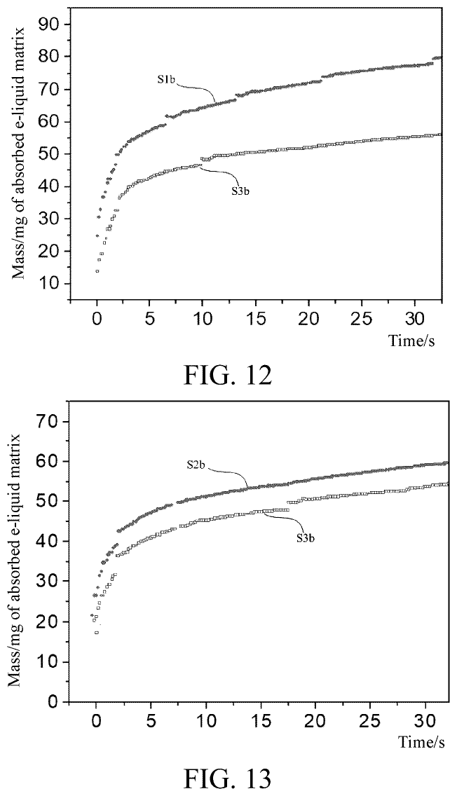

Specifically, further, FIG. 12 shows a diagram of test results of comparison between the absorption rate of the porous body 30 having the void ratio of 66.9% and the median pore diameter of 10.9 μm of Embodiment 1 in FIG. 11 on the e-liquid matrix and the absorption rate of the porous body prepared by sintering the pore-forming material in the comparative example 1 on the e-liquid matrix. In addition, FIG. 13 shows a diagram of test results of comparison between the absorption rate of the porous body 30 having the void ratio of 63.2% and the median pore diameter of 26.5 μm of Embodiment 2 in FIG. 11 on the e-liquid matrix and the absorption rate of the porous body prepared by sintering the pore-forming material in the comparative example 1 on the e-liquid matrix. Curve S1b in FIG. 12 represents a curve of the absorption rate of the porous body 30 in Embodiment 1 on the e-liquid matrix; curve S2b in FIG. 13 represents a curve of the absorption rate of the porous body 30 in Embodiment 2 on the e-liquid matrix; and curve S3b in FIG. 12 and FIG. 13 represents a curve of the absorption rate of the porous body in Comparative Example 1 on the e-liquid matrix. In a comparison test on the absorption rate on the e-liquid matrix, the e-liquid matrix uses a mixture with PG: VG=1:1. Automatic test equipment is a Sartorius ceramic atomization core oil absorption rate/void ratio/density tester (MAY-Entris120).

Furthermore, according to the test results in FIG. 12 and FIG. 13, an average absorption rate of the porous body 30 of Embodiment 1 on the e-liquid matrix in the first 5 seconds is 5.8 mg/s, and an average absorption rate on the e-liquid matrix in the first 10 seconds is 6.4 mg/s. An average absorption rate of the porous body 30 of Embodiment 2 on the e-liquid matrix in the first 5 seconds is 4.8 mg/s, and an average absorption rate on the e-liquid matrix in the first 10 seconds is 5.0 mg/s. An average absorption rate of the porous body 30 of the comparative example 1 on the e-liquid matrix in the first 5 seconds is 4.0 mg/s, and an average absorption rate on the e-liquid matrix in the first 10 seconds is 4.7 mg/s. From the comparison of the test results in FIG. 12 and FIG. 13, it can be seen that the porous body 30 prepared from the gel is significantly improved in the absorption rate on the e-liquid matrix when compared with the porous body prepared by sintering the pore-forming material.

Further, in an embodiment of the present application, static absorption rates of the porous bodies of Embodiment 1, Embodiment 2, and the comparative example 1 on the e-liquid matrix. The void ratio of the micropores in the porous body 30 of Embodiment 1 is 66.9% and the median pore diameter is 10.9 μm; the void ratio of the micropores in the porous body 30 of Embodiment 2 is 63.2% and the median pore diameter is 26.5 μm; and the void ratio of the micropores in the porous body of the comparative example 1 is 54.2% and the median pore diameter is 21.3 μm. Specific test steps for the static absorption rate on the e-liquid matrix include:

S100, the sheetlike porous bodies of Embodiment 1, Embodiment 2, and the comparative example 1 on an operating table, with their surfaces 310 facing upwards. Then, a burette is used to dropwise add a drop of the e-liquid matrix to the surfaces 310 (In this specific embodiment, an e-liquid matrix containing component PG: VG=1:1 is taken as an example. One drop squeezed out of a burette is about 10 mg, which will be precisely determined based on an actual weight gain of a porous body).

S200, a contact angle tester (Biolin Scientific, Attention Theta Lite) is used to record a time point t1 when the e-liquid matrix (component PG: VG=1:1) is in contact with the surfaces 310 of the porous bodies 30, and a time point t2 when the e-liquid matrix completely disappears from the surfaces 310. A mass difference Δm between a mass of each porous body 30 before test and a mass of each porous body 30 after test is calculated by weighing the porous body 30 by a balance, thus obtaining a precise mass of the absorbed e-liquid matrix. The static absorption rate on the e-liquid matrix is calculated and estimated using Δ m/(t2−t1).

The above static absorption rate test method is repeated for three times to obtain average values, and test results are shown in the following table:

| | | Absorption rate on |
|---|---|---|
| | Parameter of inner | e-liquid matrix |
| | micropores | Δm/(t2 − t1) |
| Embodiment 1 | Median pore diameter 10.9 μm | 8.6 mg/s |
| | Void ratio 66.9% | |
| Embodiment 2 | Median pore diameter 26.5 μm | 6.7 mg/s |
| | Void ratio 63.2% | |
| Comparative | Median pore diameter 21.3 μm | 3.3 mg/s |
| example 1 | Void ratio 54.2% | |

According to the above, the absorption rate of the porous body 30 prepared in some embodiments on the e-liquid matrix is greater than 5.0 mg/s. Alternatively, in still some embodiments, the absorption rate of the porous body 30 on the e-liquid matrix is greater than 6.0 mg/s.

In addition, in some embodiments, the porous body 30/30a has a three-dimensionally connected mesh framework, so that this porous body has higher strength than the porous body that is formed by sintering the ceramic particles and the pore-forming material. Specifically, in some embodiments, when the void ratio of the porous body 30/30a reaches 60%, the strength is greater than 35 MPa. More preferably, when the void ratio of the porous body 30/30a reaches 60%, the strength is greater than 40 MPa.

Further, for pressure test results of the national standard mechanical strength of a silicon dioxide porous body 30 prepared in another specific embodiment and a silicon dioxide porous body that is prepared by sintering a pore-forming material and has the same size in a comparative example, refer to the following table:

| | Void ratio | Pressure | Force-bearing area | Strength |
|---|---|---|---|---|
| Embodiment 3 | 66.9% | 918N | 0.21 cm² | 43.7 MPa |
| Comparative | 53.4% | 650N | 0.28 cm² | 23.2 MPa |
| example 3 | | | | |

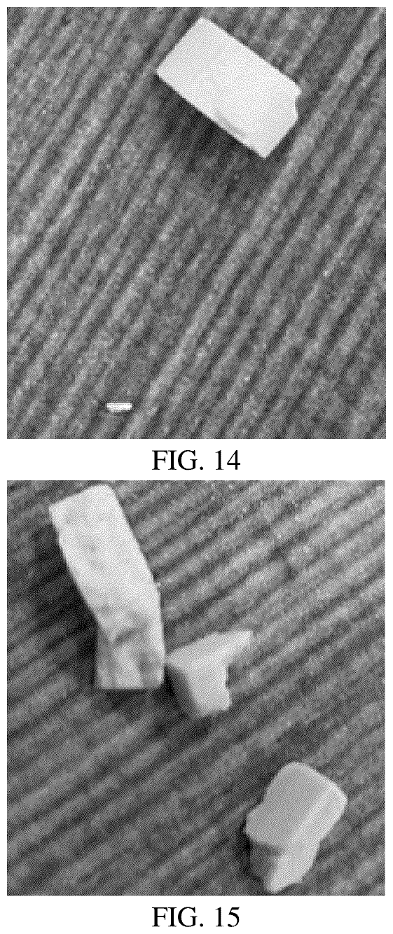

Apparently, if the void ratio of the porous body 30 of Embodiment 3 is greater than that of the porous body of the comparative example 3, the mechanical strength in the pressure test is higher than the strength of the porous body prepared by sintering the pore-forming material. In this embodiment, the three-dimensionally connected framework in the porous body 30 prepared by sintering gel is beneficial to improving the strength. Further, FIG. 14 shows a schematic diagram of a broken state of the porous body 30 of Embodiment 3 after the porous body is broken under an excessive external force, and FIG. 15 shows a schematic diagram of a broken state of the porous body of the comparative example 3 after the porous body is broken under an excessive external force. From the comparison between FIG. 14 and FIG. 15, it can be clearly seen that the porous body prepared by sintering the pore-forming material in the comparative example 3 is broken into several small pieces and there is powder produced. The porous body 30 of Embodiment 3 has a lower degree of breakage and almost no powder is produced, making it more advantageous in terms of strength.

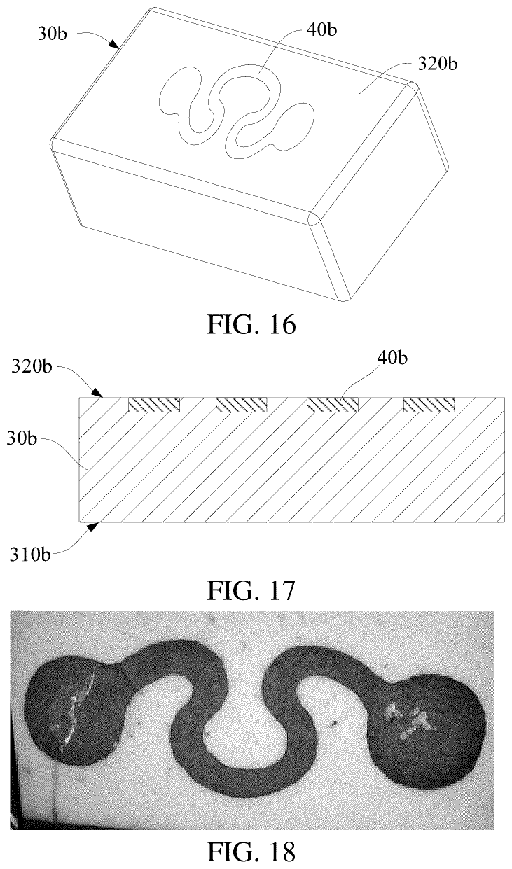

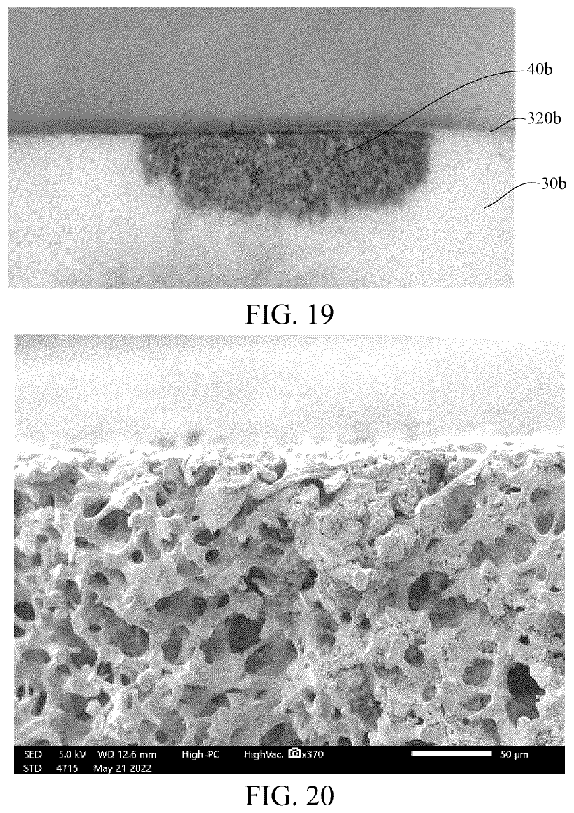

Further, based on the characteristic of the smooth surface of the framework of the porous body 30 in this embodiment, FIG. 16 to FIG. 20 show schematic diagrams of an atomization assembly prepared in another embodiment. The atomization assembly includes:
a porous body 30b, which is prepared by sintering the above gel and has a surface 310b and a surface 320b facing away from the surface 310b; and
a heating element 40b, which is formed by printing, depositing, or spraying slurry that contains a resistive metal or alloy onto the surface 320b and then performing sintering and solidification.

In addition, in this embodiment, the heating element 40c is embedded or infiltrates into the porous body 30B from the surface 320b. In addition, the formed heating element 40c is flush with the surface 320b of the porous body 30b. Specifically, due to a smooth surface of a framework of the porous body 30b, it is very easy for the flowable resistive metal or alloy slurry to flow and infiltrate into the porous body 30b in the printing process. The heating element 40c embedded into the surface 320b of the porous body 30b is formed by sintering.

In some implementations, a depth of the heating element 40b infiltrating into the surface 320b or a thickness of the heating element 40b is about 50 to 500 micrometers.

In addition, in this embodiment, the resistive metal or alloy slurry is formed by mixing powder of the metal or the alloy with an organic liquid sintering aid. In general implementation, the organic liquid sintering aid is a commonly used mixed aid in the field of powder metallurgy, which mainly includes an organic solvent, a plasticizer, a leveling agent, and the like.

From the microstructure diagram in FIG. 20, it can be seen that the right part shows an appearance in which the micropores inside the porous body 30b are basically occupied by the heating element 40b after the heating element 40b infiltrates into the porous body 30b during the slurry sintering. The left part in FIG. 20 shows an appearance in which the porous body 30B that is not infiltrated or occupied by the heating element 40b.

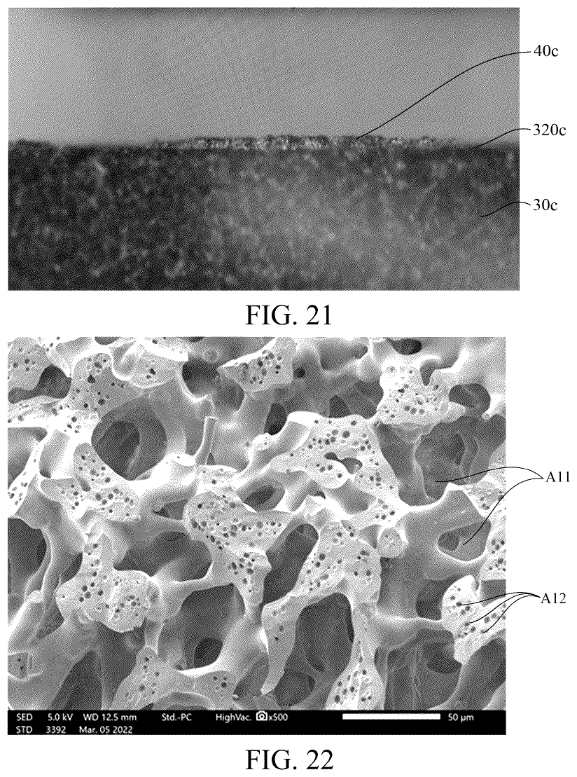

Alternatively, in some other embodiments, for example, as shown in FIG. 21, a heating element 40c protrudes out of a surface 320c of a porous body 30c. Specifically, in this embodiment, the heating element 40c protrudes out of the surface 320c through surface mounting or by shortening the slurry sintering time.

Further, FIG. 22 shows a cross-sectional diagram, scanned by an electron microscope, of a porous body 30 prepared in another embodiment. In the porous body 30 prepared in this embodiment, two levels of micropores are formed. Specifically, as shown in FIG. 22, the porous body includes:
first-level micropores A11, where boundaries of the first-level micropores are defined by a smooth surface of a framework network 301 of the porous body 30. The micropores A11 are at least partially defined by a space occupied by a solvent that loses fluidity during gelation. The micropores A11 are basically three-dimensionally connected or co-continuous; and the micropores A11 are basically open pores. The micropores A11 are uniformly distributed inside the porous body 30. In addition, the micropores A11 can basically be detected by the national standard mercury intrusion method, and a proportion of micropores A11 having pore diameters of 5 to 50 μm is greater than 80%.

The porous body includes second-level micropores A12, formed or located inside a material of the framework network 301 of the porous body 30. The micropores A12 are basically preliminarily formed in phase separation and aging of a gel body in the preparation process, and are then finally formed after being further expanded by shrinking the gel framework in the drying and sintering processes. Most of the micropores A12 are closed pores. Of course, by controlling the degree of shrinkage of the framework through sintering, some micropores A12 can be further expanded to the surface of the framework of the porous body 30 and become open pores, but a number of the open pores is obviously smaller than a number of the closed pores. Moreover, the pore diameter of each micropore A12 is significantly less than the pore diameter of each micropore A11 usually at an order of magnitude. In some implementations, the pore diameter of each micropore A12 is less than 2 μm. Alternatively, in some implementations, a median pore diameter of each micropore A12 is less than 1 μm. In more embodiments, the median pore diameter of each micropore A12 is 0.1 μm to 1 μm.

From the above, it can be seen that the micropores A11 are basically co-continuous open pores. Alternatively, the number of the open pores among the micropores A11 is larger or much larger than the number of the closed pores. The number of the closed pores among the micropores A12 is larger than the number of the open pores.

Moreover, due to the small pore diameter and the large number of the closed pores, it is hard to detect the micropores A12 using the national standard mercury intrusion method. In this embodiment, the micropores A12 can be detected by a scanning electron microscope. For example, the micropores A12 are clearly visible with the naked eyes at a magnification factor of 300 higher. For example, the magnification factor is 500 in FIG. 22.

The micropores A12 formed within the framework of the porous body 30 are advantageous for reducing or minimizing the absorption of heat from the heating element 40 by the framework, or reducing transferring of heat from the heating element 40 to the porous body 30 and/or the framework of the porous body 30.

Moreover, from FIG. 22, it can be seen that the micropores A11 are basically uniformly or co-continuously formed between in the framework of the porous body 30. The micropores A11 are basically three-dimensionally connected to each other. The plurality of micropores A12 are separated from each other or are discretely distributed in the framework of the porous body 30. The plurality of micropores A12 are basically not connected to each other. Moreover, from FIG. 22, it can be further seen that the micropores A11 and the micropores A12 are basically not connected. Alternatively, the micropores A11 and the micropores A12 are isolated by the framework of the porous body 30.

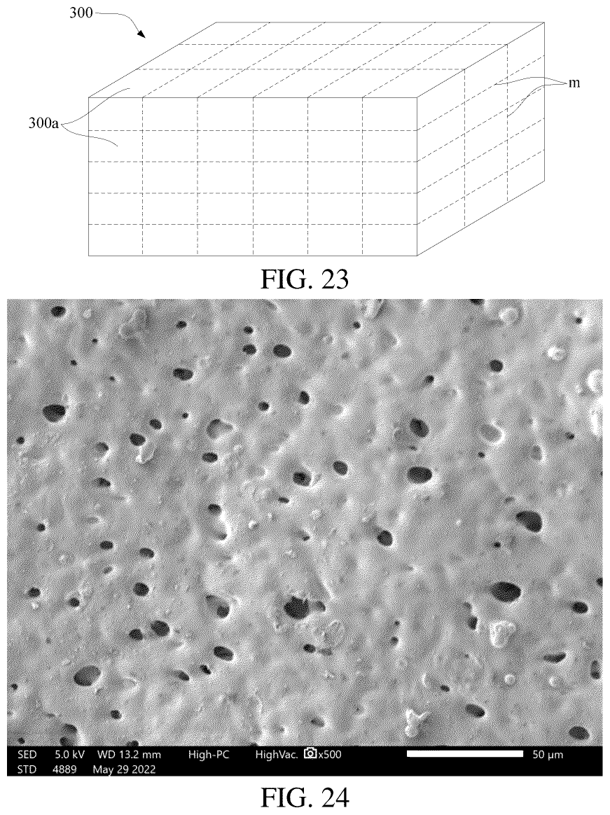

Further, FIG. 23 shows a schematic diagram of formation of a block-shaped porous gel body in a mold during mass preparation of porous bodies 30 in an embodiment. In a preparation process, the porous gel obtained by the phase separation of step S10 is injected into a square mold for aging or molding to form a porous gel body 300. The porous gel body 300 has an outer surface 300a which abuts against an inner wall of the mold. During the aging or molding of the gel, the restriction of a space of the inner wall of the mold makes the gel on a surface layer shrink during the aging, so that a pore or a pore diameter on the surface layer of the aged gel body is smaller than that inside the gel body. Further, after the sintering, a large number of porous bodies 30 can be obtained by cutting and separation according to cutting lines in FIG. 23 using a grinding wheel, a cutter, an electric saw, or the like. Surfaces of some of the multiple porous bodies 30 obtained by cutting and separation are defined by the surface layer of the porous gel body 300.

Further, FIG. 24 shows a cross-sectional diagram, scanned by an electron microscope, of a porous body 30 prepared in another embodiment, which has a surface formed by the surface layer of the porous gel body 300. Further, as shown in FIG. 24, the surface of the porous body 30 defined by the outer surface 300a of the porous gel body 300 is basically flat or smooth. Moreover, pore diameters of 80% of remaining micropores on the surface of the porous body 30 defined by the outer surface 300a of the porous gel body 300 are about 0.5 to 5 μm, and this pore diameter is smaller than a median pore diameter of each micropore inside the porous body 30.

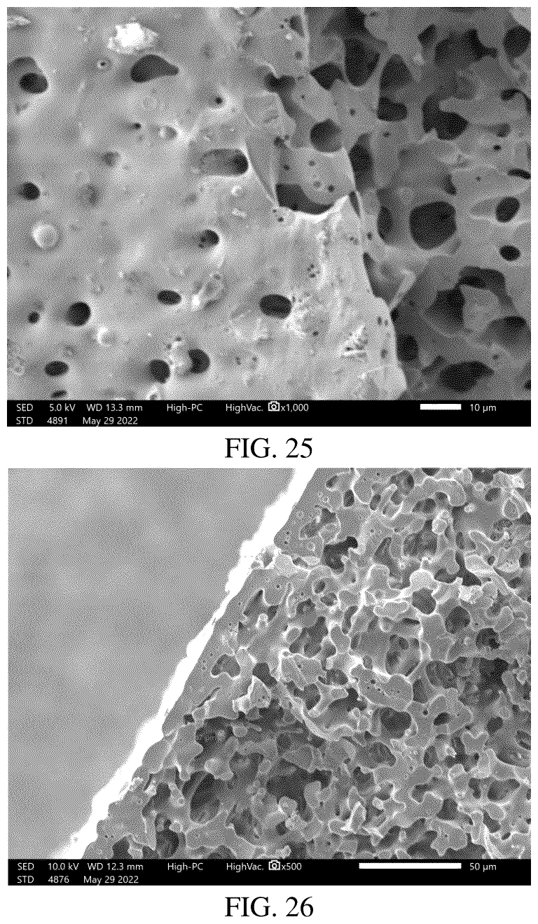

Meanwhile, FIG. 25 and FIG. 26 show cross-sectional views, scanned by an electron microscope at different magnification factors, of a porous body 30 having the surface layer of the porous gel body 300 in an embodiment. Specifically, in the cross-sectional view of the porous body 30 shown in FIG. 25, the left part shows the surface layer of the porous gel body 300, and the right part is formed by sintering the interior of the gel body. Apparently, a pore diameter and/or a void ratio of the surface layer are significantly smaller than a pore diameter and/or a void ratio of the interior. Further, in the cross-sectional view shown in FIG. 26, a thickness of the surface layer indicated is about 10 micrometers.

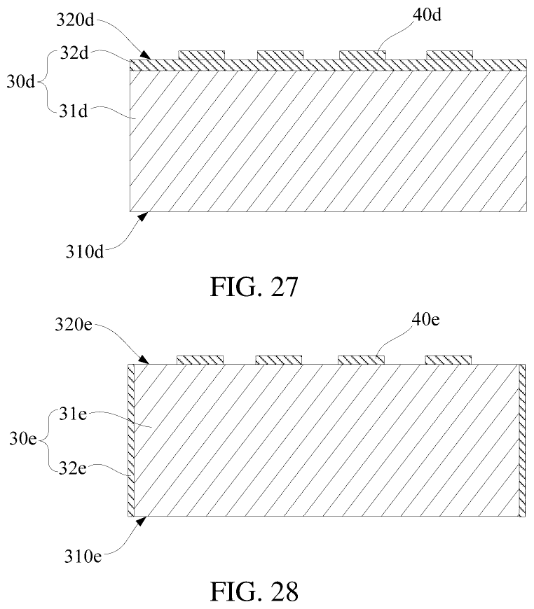

Another embodiment of the present application further provides an atomization assembly including the porous body 30 obtained by cutting after sintering of the above porous gel body 300, as shown in FIG. 27, including:
a porous body 30d, prepared by sintering the above porous gel body 300. The porous body 30d may be block-shaped, or plate-like, or in more shapes. Meanwhile, the porous body 30d includes a surface 310d and a surface 320d facing away from the surface 310d. The surface 310d serves as an e-liquid absorbing surface for absorbing an e-liquid matrix, and the surface 320d is an atomization surface for forming or being bonded with a heating element 40d.

The porous body 30d has a main body portion 31d and a surface layer portion 32d. In addition, the surface layer portion 32d is defined by the surface layer of the porous gel body 300, and the main body portion 31d is defined by an internal portion of the porous gel body 300. Moreover, a pore diameter and/or a void ratio of the surface layer portion 32d is smaller than a pore diameter and/or a void ratio of the main body portion 31d. A thickness of the surface layer portion 32d may be adjusted by controlling aging time and a shrinkage volume of the porous gel body 300, so that the thickness of the surface layer portion 32d is 0.1 to 100 micrometers. Alternatively, in more embodiments, the thickness of the surface layer portion 32d is 1 to 10 micrometers. In addition, the void ratio of the surface layer portion 32d obtained by sintering the surface layer of porous gel body 300 is usually less than 50%. Alternatively, in some embodiments, the void ratio of the sintered surface layer portion 32d is less than 30%. The void ratio of the main body portion 31d is greater than 50% or above.

In addition, the pore diameter of each micropore in the surface layer portion 32d obtained by sintering the surface layer of porous gel body 300 is usually 0.5 to 5 μm. The pore diameter of each micropore in the main body portion 31d is 10 to 50 μm.

Furthermore, in this implementation, the surface layer portion 32d has a surface 320d, and the heating element 40d is bonded to the surface 320d. Since the surface 320d is flat relative to the main body portion 31d inside, it is advantageous for enhancing the bonding strength of the heating element 40d. Moreover, it is advantageous for enhancing the e-liquid locking ability of the surface 320d, so that e-liquid maintained in the main body portion 31d is less likely to leak or overflow from the surface 320d.

Alternatively, FIG. 28 shows an atomization assembly including the porous body 30 obtained by cutting after sintering of the above porous gel body 300 in another implementation, as shown in FIG. 28, including:
a porous body 30c, prepared by sintering the above porous gel body 300. The porous body 30e may be block-shaped, or plate-like, or in more shapes. Meanwhile, the porous body 30c includes a surface 310e and a surface 320e facing away from the surface 310e. The surface 310e serves as an e-liquid absorbing surface for absorbing an e-liquid matrix, and the surface 320c is an atomization surface for forming or being bonded with a heating element 40c.

The porous body 30e includes a main body portion 31e and at least one surface layer portion 32e located on a side surface. The main body portion 31e is formed by sintering part of the interior of the porous gel body 300, and the surface layer portion 32e is formed by sintering the surface layer of the porous gel body 300. A pore diameter and/or a void ratio of the surface layer portion 32e is smaller than a pore diameter and/or a void ratio of the main body portion 31c. Moreover, in this embodiment, the at least one surface layer portion 32e extends between the surface 310c and the surface 320e. In addition, the at least one surface layer portion 32e is located on a peripheral side of the porous body 30c. It is advantageous for preventing an e-liquid matrix maintained in the porous body 30e from seeping out from the at least one peripheral surface, or for enhancing the e-liquid locking ability of the at least one peripheral surface of the porous body 30c.

In the above embodiment, a surface of the porous body 30 defined by the sintering of the outer surface 300a of the porous gel body 300 is not used as the surface 310d/310e for e-liquid absorption or avoids the surface 310d/310e for e-liquid absorption, to prevent a decrease in the absorption rate of the porous body 30 on the e-liquid matrix.

The surface layer portion 32d/32e and the main body portion 31d/31e are respectively defined by different portions of the porous gel body 300. Furthermore, the surface layer portion 32d/32e is molded with the main body portion 31d/31e by one-step sintering.

It should be noted that, the specification and the accompanying drawings of the present application illustrate preferred embodiments of the present application, but the present application is not limited to the embodiments described in this specification. Further, a person of ordinary skill in the art may make improvements or modifications according to the foregoing description, and all the improvements and modifications shall fall within the protection scope of the appended claims of the present application.

Finally, it should be noted that: the foregoing embodiments are merely used for describing the technical solutions of the present application, but are not intended to limit the present application. Under the ideas of the present application, the technical features in the foregoing embodiments or different embodiments may alternatively be combined, the steps may be performed in any order, and many other changes of different aspects of the present application also exists as described above, and these changes are not provided in detail for simplicity. Although the present application is described in detail with reference to the foregoing embodiments, it should be appreciated by a person skilled in the art that, modifications may still be made to the technical solutions described in the foregoing embodiments, or equivalent replacements may be made to the part of the technical features; these modifications or replacements will not cause the essence of the corresponding technical solutions to depart from the scope of the technical solutions in the various embodiments of the present application.

1. An atomizer, comprising:
an e-liquid storage cavity, configured to store an e-liquid matrix;
a porous body, communicated to the e-liquid storage cavity to absorb the e-liquid matrix; and
a heating element, at least partially bonded with the porous body, to heat at least part of the e-liquid matrix in the porous body to generate an aerosol,
wherein the porous body is formed by sintering gel, and the gel is obtained by gelation of sol that contains silicon and/or a metal.

2. The atomizer according to claim 1, wherein the sol that contains the silicon and/or the metal comprises a silicon source precursor and/or a metal source precursor, a water-soluble polymer, and a solvent.

3. The atomizer according to claim 2, wherein the silicon source precursor comprises at least one of methyl orthosilicate, ethyl orthosilicate, methyl trimethoxy-silane, methyl trihexaoxy-silane, and a derivative;
and/or, the metal source precursor comprises at least one of an organic alkoxide of the metal and an inorganic salt of the metal.

4. The atomizer according to claim 1, wherein the porous body comprises:
a framework network, wherein a surface of the framework network defines micropores for allowing an e-liquid matrix to flow;
the surface is smooth; and/or the surface is smoother than a surface of a framework of porous ceramic obtained by sintering a pore-forming material.

5. The atomizer according to claim 1, wherein a void ratio of the porous body is 55% to 80%.

6. The atomizer according to claim 1, wherein a median pore diameter of each micropore in the porous body is in a range of 0.3 to 50 micrometers.

7. The atomizer according to claim 1, wherein the porous body comprises less than three types of oxides with mass percentage exceeding 5%.

8. The atomizer according to claim 7, wherein the porous body comprises silicon dioxide.

9-10. (canceled)

11. The atomizer according to claim 1, wherein the micropores in the porous body are basically three-dimensionally connected, to form a network of interconnected holes in the porous body.

12. The atomizer according to claim 1, wherein a proportion of micropores, having the pore diameters of 15 to 36 micrometers, among all the micropores in the porous body is greater than 80%.

13. The atomizer according to claim 1, wherein a proportion of micropores, having the pore diameters of 5 to 20 micrometers, among all the micropores in the porous body is greater than 90%.

14-15. (canceled)

16. The atomizer according to claim 1, wherein the porous body comprises:
a framework network;
first-level micropores, wherein boundaries of the first-level micropores are defined by a surface of the framework network, to provide channels for allowing the e-liquid matrix to flow; and
second-level micropores, formed inside a material of the framework network.

17. The atomizer according to claim 16, wherein the first-level micropores are basically open pores; or, a quantity of the open pores in the first-level micropores is greater than a quantity of closed pores; or
the second-level micropores are basically closed pore; or, a quantity of the closed pores in the second-level micropores is greater than a quantity of open pores.

18-19. (canceled)

20. The atomizer according to claim 16, wherein a median pore diameter of each first-level micropore is greater than a median pore diameter of each second-level micropore.

21. (canceled)

22. The atomizer according to claim 16, wherein the first-level micropores are basically connected to each other in the framework network;
and/or, the second-level micropores are basically separated or discretely arranged inside the material of the framework network.

23-32. (canceled)

33. An electronic atomization device, comprising an atomizer for atomizing an e-liquid matrix to generate an aerosol, and a power supply mechanism for supplying power to the atomizer, wherein the atomizer comprises the atomizer according to claim 1.

34. A porous body for an electronic atomization device, wherein the porous body is formed by sintering gel, and the gel is obtained by gelation of sol that contains silicon and/or a metal.

35. A preparation method of a porous body for an electronic atomization device, comprising: sintering gel obtained by gelation of sol that contains silicon and/or a metal.

36. The preparation method of the porous body for the electronic atomization device according to claim 35, wherein the sol that contains the silicon and/or the metal comprises a silicon source precursor and/or a metal source precursor, a water-soluble polymer, and a solvent.

37. The preparation method of the porous body for the electronic atomization device according to claim 36, wherein the silicon source precursor comprises at least one of methyl orthosilicate, ethyl orthosilicate, methyl trimethoxy-silane, methyl trihexaoxy-silane, and a derivative;
and/or, the metal source precursor comprises at least one of an organic alkoxide of the metal and an inorganic salt of the metal.
